(19) United States
(12) Patent Application Publication
(10) Pub. No.: US 2008/0266846 A1
(43) Pub. Date: Oct. 30, 2008

(54) Solar Lamp with a Variable Display

(75) Inventors: Bob Chi-Chung Cheng, Quarry Bay (HK); Andrew C. Li, Laguna City (HK)

Correspondence Address: BANNER & WITCOFF, LTD., TEN SOUTH WACKER DRIVE, SUITE 3000, CHICAGO, IL, 60606, US

(73) Assignee: Computime, Ltd., Kwung Tong (HK)

(21) Appl. No.: 11/739,233

(22) Filed: Apr. 24, 2007

(51) Int. Cl. F21L 4/08

(52) U.S. Cl. 362/183

(57) ABSTRACT

The present invention supports a solar lamp that includes a solar panel that charges a battery to power a display panel and a processor. Based on environmental factors measured by a sensor, the processor instructs the display panel to change colors based on the value of an environmental factor. If the measured environmental factor changes values, the processor may subsequently instruct the display panel to change colors. The solar lamp may be controlled by a remote controller. The solar lamp has a receiver circuit that receives control data from the remote controller to configure the display panel. Based on the control data, a processor may instruct the display panel to change colors or change intensity. The remote controller controls a solar lamp through a wireless communications channel. Based on an indication, a processor sends control data through a wireless transmitter circuit to configure the display panel of the solar lamp.

### FIELD OF THE INVENTION

The present invention relates to a solar lamp that is indicative of environmental conditions and that may be controlled by a remote controller.

### BACKGROUND OF THE INVENTION

Solar lamps and lanterns are often placed for outdoor use in the front yard, backyard or garden so that the lamps can absorb the sunlight during daylight hours and convert the sunlight into electrical energy to turn on and off the lamps. The solar lamps are typically designed for either illumination or decoration by its product design, light color and light intensity.

Typically, a solar lamp merely provides an automatic switch using a light sensor to turn on the solar lamp during nighttime, turn off the solar lamp during daylight. Also, the solar lamp may have a manual switch for a user to shut off the solar lamp or to change operation to the automatic mode.

Thus, there is a real market need to enhance the operation of a solar lamp and to provide additional functionality other than simple illumination.

### SUMMARY OF THE INVENTION

With an aspect of the invention, a solar lamp includes a solar panel that charges a battery to power a display panel and a processor. The display panel has a first color component configured to emit at a first color and a second color component to emit at a second color.

Based on environmental factors measured by a sensor, the processor instructs the display panel to change colors based on the value of an environmental factor. If the measured environmental factor changes values, the processor may subsequently instruct the display panel to change colors.

With another aspect of the invention, the display panel includes a plurality of light emitting diodes (LEDs) having different colored LEDs. The appropriate colored LEDs are activated to obtain the desired color for the display panel.

With another aspect of the invention a solar lamp is controlled by a remote controller. The solar lamp has a receiver circuit that receives control data from the remote controller to configure the display panel. Based on the control data, a processor may instruct the display panel to change colors or change intensity.

With another aspect of the invention, a remote controller controls a solar lamp through a wireless communications channel. Based on an indication, a processor sends control data through a wireless transmitter circuit to configure the display panel of the solar lamp. The indication may be provided by a program timer, a light sensor, or a user interface. The remote controller may configure characteristics of the display panel, including the color or intensity.

### BRIEF DESCRIPTION OF THE DRAWINGS

The foregoing summary of the invention, as well as the following detailed description of exemplary embodiments of the invention, is better understood when read in conjunction with the accompanying drawings, which are included by way of example, and not by way of limitation with regard to the claimed invention.

FIG. 1 shows a solar lamp in accordance with an embodiment of the invention.

FIG. 2 shows a flow diagram for controlling a solar lamp from a remote controller in accordance with an embodiment of the invention.

FIG. 3 shows a flow diagram for controlling a solar lamp when temperature changes in accordance with an embodiment of the invention.

FIG. 4 shows a remote controller in accordance with an embodiment of the invention.

### DETAILED DESCRIPTION OF INVENTION

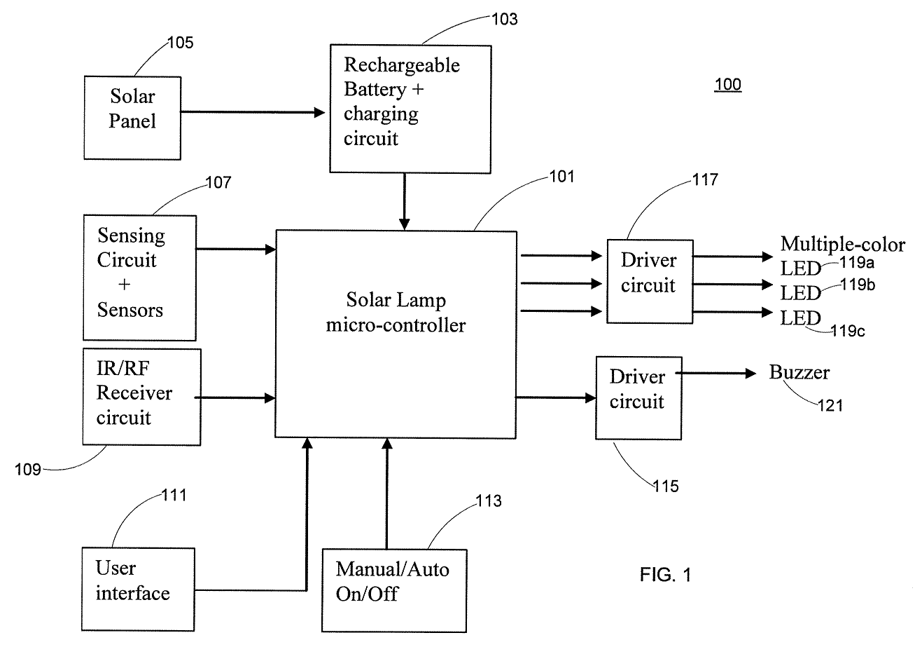

FIG. 1 shows solar lamp 100 in accordance with an embodiment of the invention. Solar lamp 100 includes solar panel 105 that converts solar light into electrical energy in order to recharge rechargeable battery 103. Battery 103 provides electrical energy to power microprocessor 101 and the display panel that includes driver circuits 115 and 117 and light emitting diodes (LEDs) 119a-119c. Solar lamp 100 typically charges battery 103 during daylight hours and emits light through LEDs 119a-119c during night hours. With an embodiment of the invention, LEDs 119a, 119b, and 119c emit at first, second, and third colors, respectively. With embodiments of the invention, the display panel comprises a plurality of LEDs, where different colored LEDs are distributed evenly over the display panel. Processor 101 instructs the desired set of LEDs to emit a desired color.

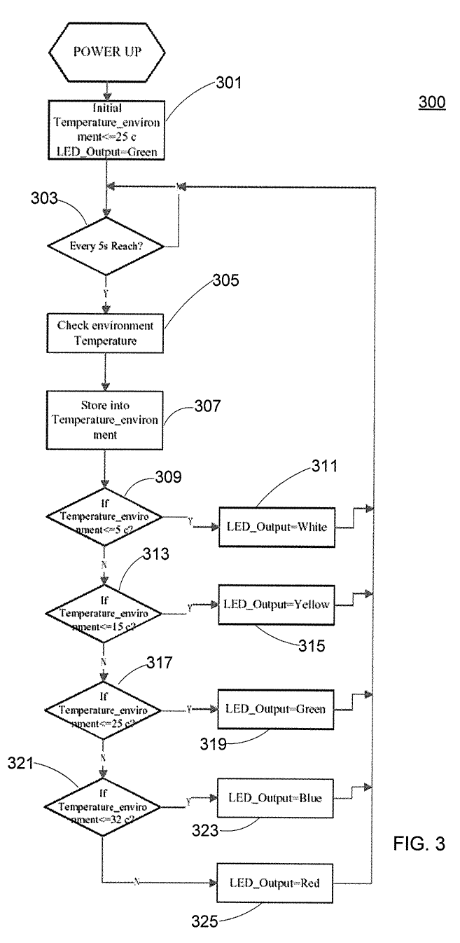

Processor 101 instructs LEDs to emit light based on determined environmental conditions that are measured by sensing circuit 107. For example, as will discussed in more detail in FIG. 3, sensing circuit 107 may measure the outside temperature and instruct the display panel to emit at a corresponding emitted color (e.g., green, yellow, or red) based on the range of the measured temperature.

Different types of sensors (either individually or in combination) may be incorporated into sensing circuit 107. Sensors inside solar lamp 100 may measure the following environments factors:

Temperature

Relative humidity

Atmospheric pressure

Wind speed

Soil wetness

Salinity

Ultra-violet intensity

For example, when outdoor temperature is within a certain temperature preset temperature range, a three-color (red, blue, amber) solar lamp with a built-in temperature sensor emits a red color. As another example, a three-color (green, blue, red) solar lamp with an atmospheric pressure sensor emits a corresponding color based on a change of atmospheric pressure. Electronic circuitry in the solar lamp tracks the barometric data and predicts weather conditions for the subsequent of 12 hours. The solar lamp emits blue for predicted sunny weather, green for predicted cloudy weather, and red for predicted rainy weather. In addition, embodiments of the invention may alert a user of a predicted weather condition through an auditory output device (e.g., buzzer 125).

In addition to being automatically controlled based on environmental conditions, solar lamp 100 may be controlled from a remote controller (not shown) over a wireless communications channel through receiver circuit 109 when in the manual mode. Solar lamp 100 may be instructed to be in the automatic mode or the manual mode through automatic/manual switch 113. The wireless communications channel may span different frequency spectra, including radio frequency (RF) and infra-red (IR).

With embodiments of the invention, solar lamp 100 may be activated or deactivated through user interface 111. Also, a user may configure the environmental setting through user interface 111. For example, the upper and lower bounds of a temperature range may be configured in which a corresponding color is emitted by solar lamp 100.

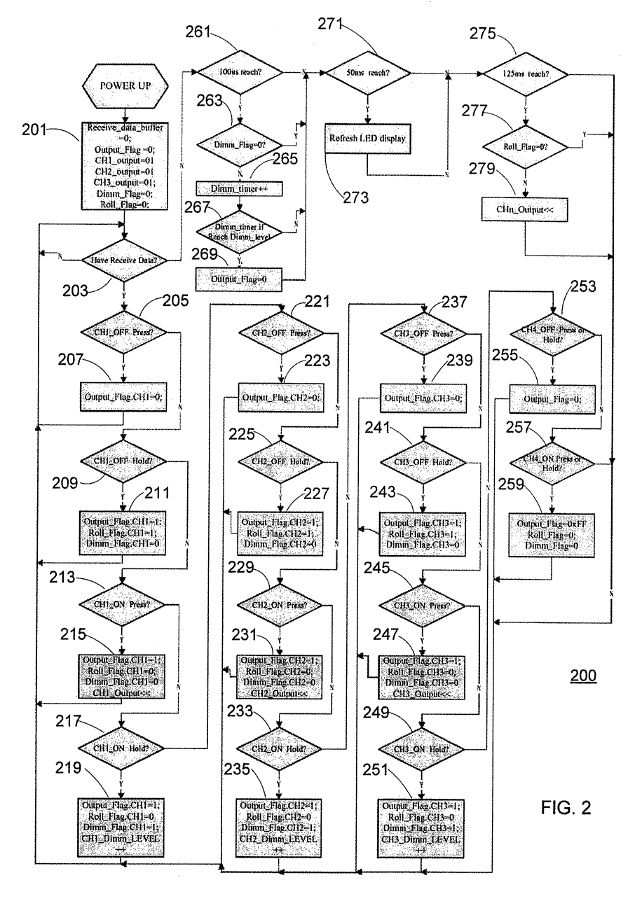

FIG. 2 shows flow diagram 200 for controlling a solar lamp from a remote controller (over a wireless communications channel) in accordance with an embodiment of the invention. Embodiments of the invention enable solar lamp 100 to operate in the manual mode, where solar lamp 100 is controlled through a remote controller. With embodiments of the invention, the remote controller is able to communicate with a plurality of configured ID channels over a common radio-frequency channel. An ID channel is assigned to each individual solar lamp by dip switches set by an end user, where dip switches are typically located inside the compartment of the solar lamp. After ID channel configuration, the remote controller can communicate through the single radio-frequency channel to each individual solar lamp by the known ID followed by control codes.)

Embodiments of the invention support multi-channel remote control of solar lamp 100. Consequently, a user may enable the user to manually control various solar lamps which may be placed on a lawn, in the garden, on the sidewalk, on the roof, and so forth.

A remote controller may support different control functions, including:

manually turn on/off the solar lamp, or

turn the light intensity stronger or weaker, or

change the light color if the solar lamp is multi-color

individually control each channel of solar lamp

turn all solar lamps on or off

With flow diagram 200, solar lamp 100 changes emitted color based on control data sent by a remote controller. (As shown in flow diagram 200, CHn denotes the nth ID channel, which is configured with the ID dip switches as previously discussed.) In step 201, various variables are initialized. Step 203 determines if control data has been received from the wireless controller over the wireless communications channel.

In steps 205-279, the remote control may instruct the solar lamp to activate one LED or to activate different LED's having different colors in a pre-defined sequence, e.g., red on for 3 seconds, then gradually phase in green for another 3 seconds, then phase back to red again, and so on. If the end user selects the multi-color change mode, the Roll_Flag will be set. If the end user presses the buttons of remote control to turn on the LED and continues to hold by pressing to turn LED light stronger or weaker, the DIMMER mode in software and Dimm_Flag will be set. As shown in flow diagram 200, Dimm_Level is the step level of the LED light intensity as determined by flow diagram 200.

FIG. 3 shows flow diagram 300 for controlling solar lamp 100 when the temperature changes in accordance with an embodiment of the invention. Step 301 determines whether the temperature measurement from sensor 107 is less than or equal to 25 degrees C., processor 101 instructs the display panel to emit a green color. Every 5 seconds (as determined by step 303) the temperature measurement is obtained in step 305 and stored in step 307.

If step 309 determines that the measured temperature is less than or equal to 5 degrees C., processor 101 instructs the display panel to emit a white color in step 311. With embodiments of the invention, the white color may be emitted by a white LED or a single multi-color (e.g., red-green-blue) LED. If step 313 determines that the measured temperature is between 5 to 15 degrees C., processor 101 instructs the display panel to emit a yellow color in step 315. If step 317 determines that the temperature is between 15 to 25 degrees C., processor 101 instructs the display panel to emit a green color in step 319. If step 321 determines that the measured temperature is between 25 to 35 degrees C., processor 101 instructs the display panel to emit a blue color in step 323. Otherwise, the measured temperature is greater than 32 degrees C., and processor 101 instructs display panel to emit a red color in step 325.

Solar lamp 100 may also support an output port (not shown in FIG. 1) in which an external device (not shown, e.g., a lawn sprinkler) may be controlled in accordance with a measured environmental factor. For example, an indication that is indicative of moisture (soil wetness) may be used to control the lawn sprinkler. The lawn sprinkler is activated only when the soil is sufficiently dry or deactivated when the soil is sufficiently wet.

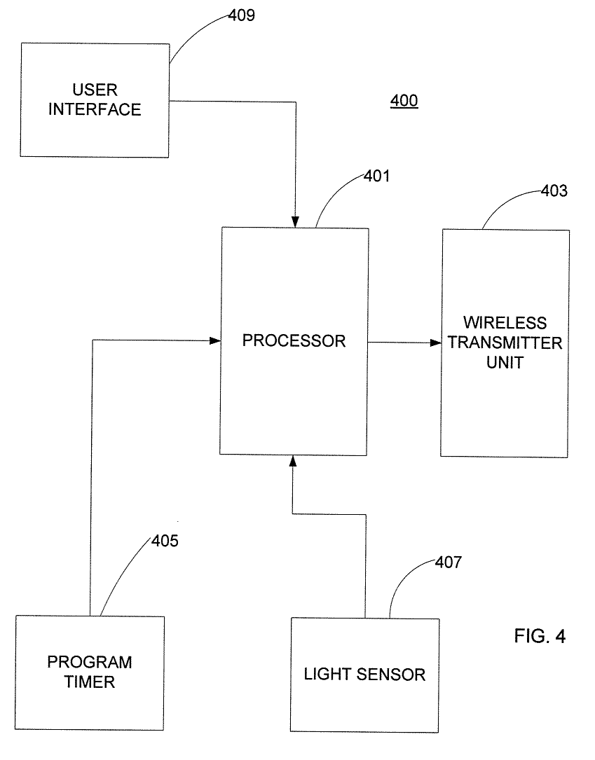

FIG. 4 shows remote controller 400 in accordance with an embodiment of the invention.

Remote controller 400 may control solar lamp 100 as well as other solar lamps through multiple wireless communications channel through wireless transmitter unit 403.

Processor 401 receives an indication from program timer 405, light sensor 407, or user interface 409. Processor 401 processes the indication and provides control data transmitter unit 403 so that the display panel of solar lamp 100 is controlled accordingly. For example, processor 401 may instruct the display panel of solar lamp 100 to change colors sequentially or periodically based on time provided by program timer 405. As another example, processor 401 may instruct the display panel of solar lamp 100 to change the intensity of light emission. Processor 401 may instruct a solar lamp over the wireless communications channel to:
turn on the light, change the light color, or change the light intensity (dimmer)
turn on/off solar lamps individually, turn on/off all solar lamps, or set the lamp color to change sequentially and periodically.
set the program timer to perform the above functions during time intervals on each solar lamp;
manually or automatically send signal to control the solar lamps on/off or lamp intensity based on a light sensor to sense sunlight intensity

User interface 409 may include a LED or LCD indicator. For example, the LED indicator may flash when the remote controller transmits control code. As another example, the LCD indicator may show program times, the dimmer level, or on/off status of the solar lamps and enable the user to change the program, change the color mode, or manually set the color mode.

As can be appreciated by one skilled in the art, a computer system with an associated computer-readable medium containing instructions for controlling the computer system can be utilized to implement the exemplary embodiments that are disclosed herein. The computer system may include at least one computer such as a microprocessor, digital signal processor, and associated peripheral electronic circuitry.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A solar lamp comprising:
a solar panel converting light to converted electrical energy;
a rechargeable battery charging unit configured to recharge a battery from the converted electrical energy, the battery providing electrical power to a processor and a display panel;
the display panel having a first color component configured to emit at a first color and a second color component to emit at a second color, the first color and the second color being different;
an environmental sensor measuring an environmental factor and providing an indication that is indicative of the environmental factor; and
the processor configured to perform:
receiving the indication from the environmental factor;
when the indication is within a first range, instructing the first color component to emit at the first color; and
when the indication is within a second range, instructing the second color component to emit at the second color.

2. The solar lamp of claim of 1, the processor being configured to perform:
when the indication from the environmental changes, determining whether to change emitted color of the display panel; and
instructing the display panel to change the emitted color of the display panel in accordance with the changed indication.

3. The solar lamp of claim 1, the display panel comprising a plurality of light emitting diodes (LEDs), the plurality of LEDs having at least one first color LED and at least one second color LED.

4. The solar lamp of claim 1, the environmental sensor comprising a temperature sensor.

5. The solar lamp of claim 1, the environmental sensor comprising a moisture sensor.

6. A solar lamp comprising:
a solar panel converting light to converted electrical energy;
a rechargeable battery charging unit configured to recharge a battery from the converted electrical energy, the battery providing electrical power to a processor and a display panel;
the display panel;
a receiver circuit configured to receive control data over a wireless communications channel; and
the processor configured to perform:
obtaining the control data from the receiver circuit; and
controlling the display panel in accordance with the control data.

7. The solar lamp of claim 6, the display panel having a first color component configured to emit at a first color and a second color component to emit at a second color, the first color and the second color being different and the processor being further configured to perform:
instructing the display panel to emit at one of the colors based on the control data.

8. The solar panel of claim 6, the processor being further configured to perform:
changing the emitted color of the display panel in accordance with the control data.

9. The solar panel of claim 6, the processor being further configured to perform:
changing light intensity of the display panel in accordance with the control data.

10. The solar panel of claim 6, the display panel comprising a plurality of light emitting diodes (LEDs), the plurality of LEDs having at least one first color LED and at least one second color LED.

11. A remote controller comprising:
a transmitter unit configured to transmit a signal to a solar lamp over a wireless communications channel; and
a processor configured to perform;
obtaining an indication; and
instructing the transmitter unit to send control data over the wireless communications channel to the solar lamp in accordance with the indication, the control data configuring a display panel of the solar lamp.

12. The remote controller of claim 1 1, the processor further configured to perform:
instructing the transmitter unit to send the control data over the wireless communications channel to another solar lamp.

13. The remote controller of claim 11, the processor further configured to perform:
instructing the transmitter unit to send different control data over the wireless communications channel to another solar lamp.

14. The remote controller of claim 11, further comprising:
a program timer providing the indication from a determined time.

15. The remote controller of claim 14, the program timer varying the indication from the determined time and the processor being further configured to perform changing the control data in accordance with the varying indication.

16. The remote controller of claim 15, the indication sequentially changing.

17. The remote controller of claim 15, the indication periodically changing.

18. The remote controller of claim 11, further comprising:
a light sensor sensing a sunlight intensity to provide the indication to the processor.

19. The remote controller of claim 18, the processor being further configured to perform:
determining an illumination intensity of the solar lamp based on the sunlight intensity.

20. The remote controller of claim 11, further comprising:
the processor further configured to perform:
determining an emitted color of the solar lamp; and
configuring the control data to be indicative of the emitted color.

21. The remote controller of claim 20, the processor being further configured to perform:
determining a different emitted color of the solar lamp; and
configuring the control data to be indicative of the different emitted color.

22. The remote controller of claim 11, further comprising:
a user interface configured to obtain a user input and determine the indication from the user input.

23. The solar lamp of claim 1, the processor being further configured to:
predict a weather condition; and
instruct the display panel to emit at an appropriate color.

24. The solar lamp of claim 1, the processor being further configured to:
control an external device in accordance with the indication from the environmental factor.
